(19) United States
(12) Patent Application Publication
(10) Pub. No.: US 2010/0306564 A1
(43) Pub. Date: Dec. 2, 2010

(54) INFORMATION PROCESSING APPARATUS AND CONTROL METHOD OF INFORMATION PROCESSING APPARATUS

(75) Inventor: Akihiro KOJO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/790,339

(22) Filed: May 28, 2010

(30) Foreign Application Priority Data
May 29, 2009 (JP) 2009-131134

(51) Int. Cl. G06F 1/32; H04N 5/38

(52) U.S. Cl. 713/323; 348/723; 348/E05.093

(57) ABSTRACT

According to one embodiment, an information processing apparatus from which a display module is detachable, the apparatus includes a processor configured to executes arithmetic processing, a controller configured to communicate with an external device, a detector configured to detect an attachment and a detachment of the display module, a determination module configured to determine whether the apparatus is permitted to be switched to a sleep state when the detector detects the detachment, a switching module configured to switch the apparatus to the sleep state when the determination module determines that the apparatus is permitted to be switched to the sleep state, and a lock module configured to inhibit a communication between the external device and the controller and to invalidate an input of data from an input device to the processor when the determination module determines that the apparatus is not permitted to be switched to the sleep state.

### CROSS-REFERENCE TO RELATED APPLICATIONS

This application is based upon and claims the benefit of priority from Japanese Patent Application No. 2009-131134, filed May 29, 2009; the entire contents of which are incorporated herein by reference.

### FIELD

Embodiments described herein relate generally to an information processing apparatus which allows a display unit and main body to be detached from each other, and a control method of the information processing apparatus.

### BACKGROUND

In recent years, computers, which allow a main body and display unit to be detached from and reattached to each other, have been developed.

When a display unit is detached from a main body, it becomes difficult for the user to control a computer. However, to leave the display unit and main body in the detached state poses a security risk. But to randomly shut down the computer for the sake of security when the display unit is detached may lose active data.

Jpn. Pat. Appln. KOKAI Publication No. 2006-258988 discloses that when the display unit is detached from the main body, the computer is set in a power saving sate and halt state.

The power saving state while a system is active is insufficient in terms of security, and cannot suppress a third party from accessing an information apparatus. When the computer is set in the power saving state and halt state in which the system is inactive after the display unit is detached, it becomes impossible to control the information apparatus to continue processing.

### BRIEF DESCRIPTION OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention.

FIG. 2 is an exemplary perspective view showing a state in which a main body and display unit of the information processing apparatus are detached from each other.

FIG. 3 is an exemplary block diagram showing the system arrangement of the information processing apparatus shown in FIG. 1.

FIG. 4 is an exemplary block diagram showing the configuration of a utility program.

FIG. 5 is an exemplary flowchart showing the sequence of processing by the utility program and an operating system.

FIG. 6 is an exemplary flowchart showing the sequence of processing by the utility program and operating system.

FIG. 7 is an exemplary view showing a state in which a single display unit is combined with a plurality of main bodies.

### DETAILED DESCRIPTION

Various embodiments according to the invention will be described hereinafter with reference to the accompanying drawings.

In general, according to one embodiment, an information processing apparatus from which a display module is detachable, the apparatus comprises an input device configured to input data to the processor, a processor configured to executes arithmetic processing, a controller configured to communicate with an external device, a detection circuit configured to detect an attachment and a detachment of the display module, a determination module configured to determine whether the information processing apparatus is permitted to be switched to a sleep state when the detection circuit detects the detachment, a switching module configured to switch the information processing apparatus to the sleep state when the determination module determines that the information processing apparatus is permitted to be switched to the sleep state, and a lock module configured to inhibit a communication between the external device and the controller and to invalidate an input of data from the input device to the processor when the determination module determines that the information processing apparatus is not permitted to be switched to the sleep state.

FIG. 1 is a perspective view showing the outer appearance of an information processing apparatus according to an embodiment of the present invention. As shown in FIG. 1, this information processing apparatus is implemented as, for example, a notebook portable personal computer 10 which can be powered by a battery.

This computer 10 includes a main body 11 and display unit 12. A keyboard 13, a power button switch 14 required to turn on/off the power supply of the computer 10, a touchpad 15, and the like are arranged on the upper surface of the main body 11. A connection port used to connect an external device is arranged on, e.g., the back or side surface of the main body 11. A display device including a liquid crystal display (LCD) 17 is built in the inner surface of the display unit 12, and the display surface of the LCD 17 is located at nearly the center of the display unit 12. The display unit 12 is supported by the main body 11, and is attached to the main body 11 to be pivotal between an open position where the upper surface of the main body 11 is exposed, and a close position where the display unit 12 covers the upper surface of the main body 11.

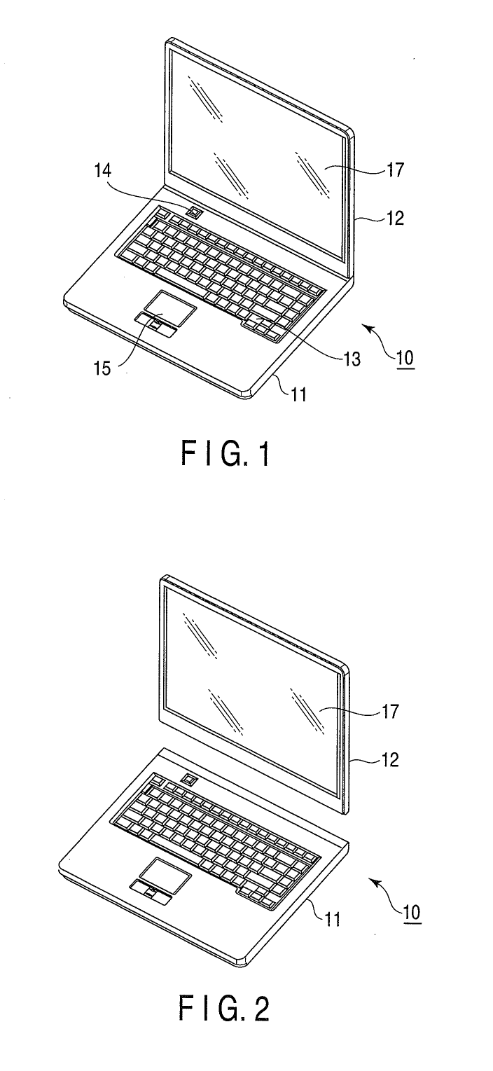

As shown in FIG. 2, the main body 11 and display unit 12 can be detached from each other. When the main body 11 and display unit 12 are detached from each other, the main body 11 transmits a signal required to display a video picture on the LCD 17 to the display unit 12 via wireless communications.

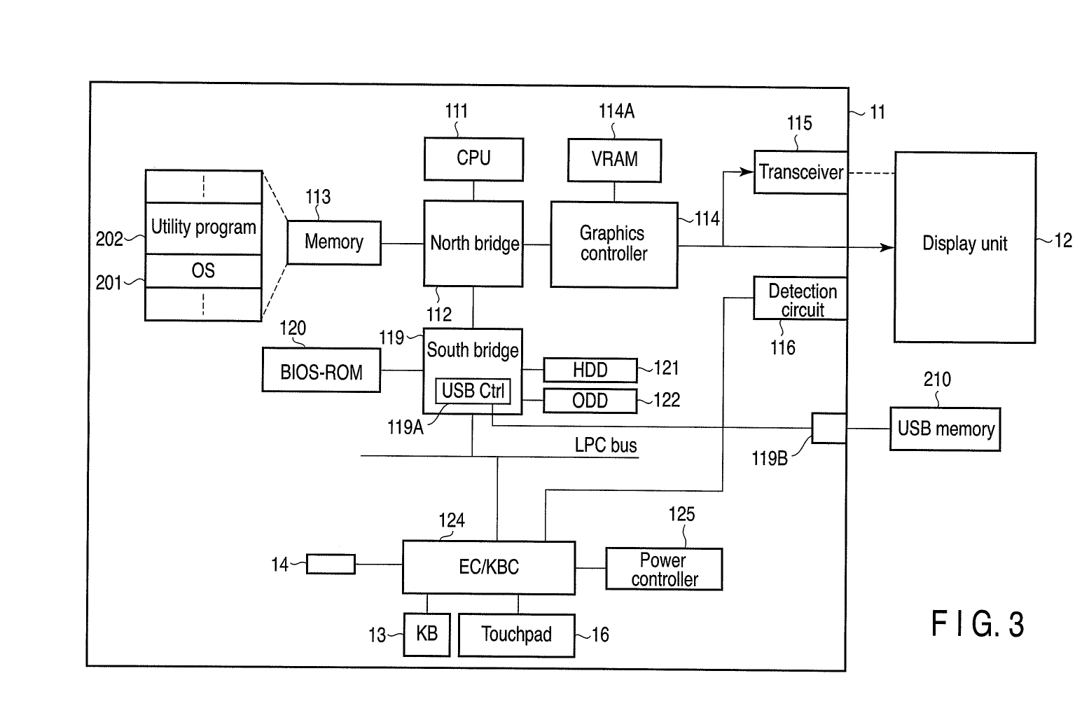

The system arrangement of this computer will be described below with reference to FIG. 3.

As shown in FIG. 3, this computer includes the display unit 12, a CPU 111, a north bridge 112, a main memory 113, a graphics controller 114, a wireless HDMI transceiver 115, a detection circuit 116, a south bridge 119, a BIOS-ROM 120, a hard disk drive 121, an embedded controller/keyboard controller IC 124, and a power controller 125.

The hard disk drive 121 stores codes required to execute various programs including an operating system (OS) and BIOS update program.

The CPU 111 is a processor arranged to control the operation of this computer, and executes various application programs which are loaded from the hard disk drive 121 onto the main memory 113 and include an operating system 201 and utility program 202.

Also, the CPU 111 executes a Basic Input/Output System (BIOS) program stored in the BIOS-ROM 120. The BIOS program is a program for hardware control.

The north bridge 112 is a bridge device which connects between a local bus of the CPU 111 and the south bridge 119. The north bridge 112 incorporates a memory controller which controls accesses to the main memory 113. The north bridge 112 also includes a function of executing communications with the graphics controller 114 via, e.g., an AGP bus.

The graphics controller 114 is a display controller which controls the LCD 17 used as a display monitor of this computer. The graphics controller 114 includes a video memory 114A, and generates a video signal required to form a display image to be displayed on the LCD 17 of the display unit 12 based on display data written in the video memory 114A by the OS/application program.

The wireless HDMI transceiver 115 transmits a video signal to the display unit 12 based on the wireless HDMI specification. The wireless HDMI transceiver 115 transmits the video signal via wireless communications when the main body 11 and display unit 12 are detached from each other. Note that the video signal may be transmitted based on the wireless USB specification in place of the wireless HDMI specification.

The detection circuit 116 detects detachment of the display unit 12 from the main body 11 and attachment of the display unit 12 to the main body 11. When the detection circuit 116 detects detachment, a video signal generated by the graphics controller 114 is transmitted to the display unit 12 by the wireless HDMI transceiver 115. When the detection circuit 116 detects attachment of the main body 11 and display unit 12, a video signal is transmitted from the main body 11 to the display unit 12 via wired communications.

The south bridge 119 controls devices on an LPC bus. The south bridge 119 incorporates an IDE controller used to control the HDD 121. Furthermore, the south bridge 119 has a function of controlling accesses to the BIOS-ROM 120. Moreover, the south bridge 119 includes a USB controller 119A required to attain data transmission control with devices which support the USB standard. To the USB controller 119A, a USB port 119B which can receive a connector of a USB device is connected. A flash drive 210 or the like is inserted into the USB port 119B.

The embedded controller/keyboard controller IC (EC/KBC) 124 is a 1-chip microcomputer which integrates an embedded controller for power management and a keyboard controller required to control the keyboard (KB) 13 and touchpad 15. This embedded controller/keyboard controller IC (EC/KBC) 124 has a function of turning on/off the power supply of the computer 10 in response to a user's operation on the power button 14.

When the main body 11 and display unit 12 are detached from each other, it is difficult for the user to control this computer 10. However, to leave the display unit and main body in the detached state poses a security risk. For example, a third party may insert a USB display or the flash drive 210 into the USB port arranged on the main body 11 to control the computer 11 and to extract data stored in the hard disk drive 121. But to randomly shut down the computer for the security sake may lose active data.

The utility program 202 of this apparatus switches the computer 10 to a secure state when the display unit 12 is detached from the main body 11. The utility program 202 or operating system 201 executes authentication processing and then resumes the computer 10 to the original state prior to the secure state when the main body 11 and display unit 12 are attached.

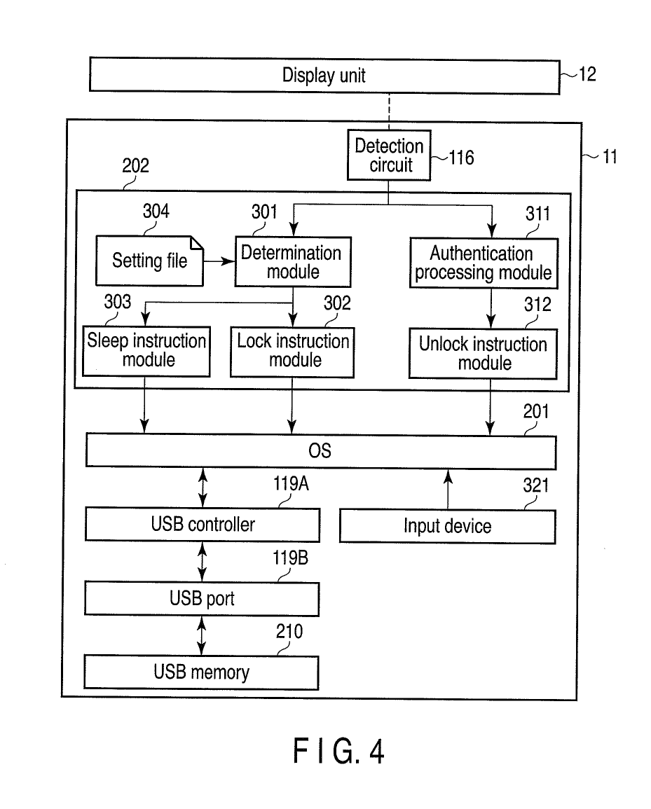

The configuration of the utility program 202 will be described below with reference to FIG. 4.

As shown in FIG. 4, the utility program 202 includes a determination module 301, lock instruction module 302, sleep instruction module 303, setting file 304, authentication processing module 311, and unlock instruction module 312.

The determination module 301 determines whether the operation of the computer 10 is locked or the computer 10 is set in a sleep state, when the detection circuit 116 detects detachment of the display unit 12.

The setting file 304 describes a setting indicating whether or not to switch the computer 10 to the sleep state when the display unit 12 is detached. The user can change the setting contents of the setting file 304.

The determination module 301 reads out the setting recorded in the setting file 304. When the setting indicates to switch the computer 10 to the sleep state, the determination module 301 determines whether or not to switch the computer 10 to the sleep state. For example, when a usage ratio of the CPU 111 is lower than a setting value (e.g., 20%), the determination module 301 determines that the computer 10 is to be switched to the sleep state. When the setting does not indicate to switch the computer 10 to the sleep state or when the usage ratio of the CPU 111 is not lower than the setting value, the determination module 301 determines that the port is to be locked. When the usage ratio of the CPU 111 is not lower than the setting value, arbitrary processing may be underway and may not want to be interrupted by the sleep state.

The lock instruction module 302 executes processing for locking the operation of the computer 10 with respect to the operating system 201. The lock instruction module 302 issues an instruction to the operating system 201 to inhibit communications between the flash drive 210 and controller (e.g., the USB controller 119A) via the USB port 119B as an external port, so as to lock the operation of the computer 10. Also, the lock instruction module 302 instructs the operating system 201 to invalidate any inputs from an input device 321 which includes the keyboard 13 and touchpad 15 and is used to input a signal to the computer 10.

In response to these instructions, the operating system 201 inhibits communications and invalidates inputs. By inhibiting communications, data in the computer 10 can be prevented from being extracted. Also, by invalidating inputs of signals from the input device 321, inhibited communications can be prevented from being released.

The sleep instruction module 303 instructs the operating system 201 to set the computer 10 in the sleep state. In response to the instruction from the sleep instruction module 303, the operating system 201 sets the computer 10 in the sleep state.

When the detection circuit 116 detects attachment of the display unit 12 while the operation of the computer 10 is locked, the unlock instruction module 312 instructs the operating system 201 not to invalidate inputs from the input device 321. Then, the authentication processing module 311 executes authentication processing. When the authentication processing of the authentication processing module 311 has succeeded, the authentication processing module 311 instructs the unlock instruction module 312 to unlock the port. In response to the instruction from the authentication processing module 311, the unlock instruction module 312 instructs the operating system 201 to permit communications between the controller 119A and the flash drive 210 connected to the port 119B.

When the detection circuit 116 detects attachment of the display unit 12 in the sleep state, an instruction for resuming the computer 10 from the sleep state is input to the operating system 201. After the computer 10 is resumed from the sleep state, the operating system 201 executes authentication processing. When the authentication processing has succeeded, the operating system 201 permits the user to operate the computer 10. The operating system 201 originally includes the function of executing the authentication processing after the computer 10 is resumed from the sleep state.

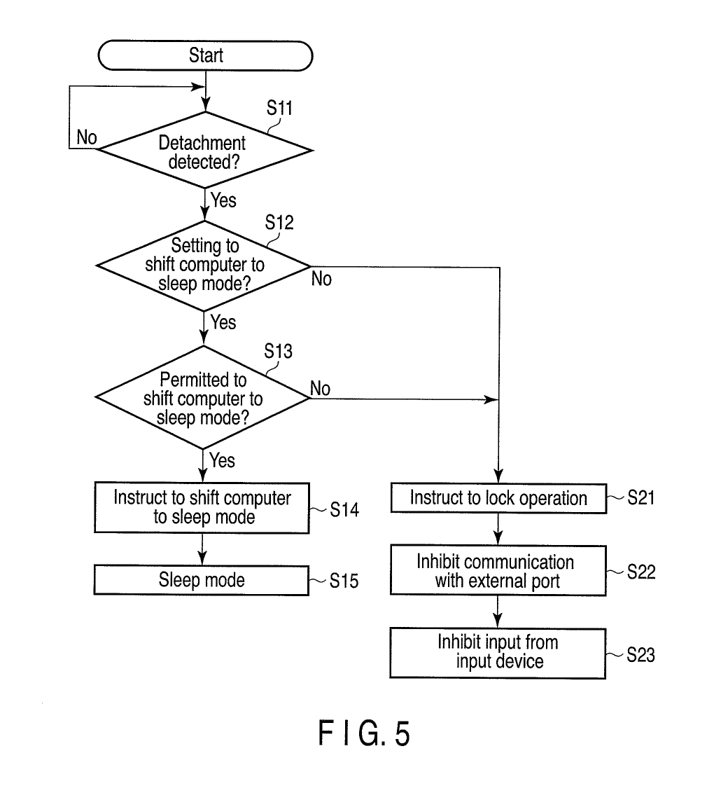

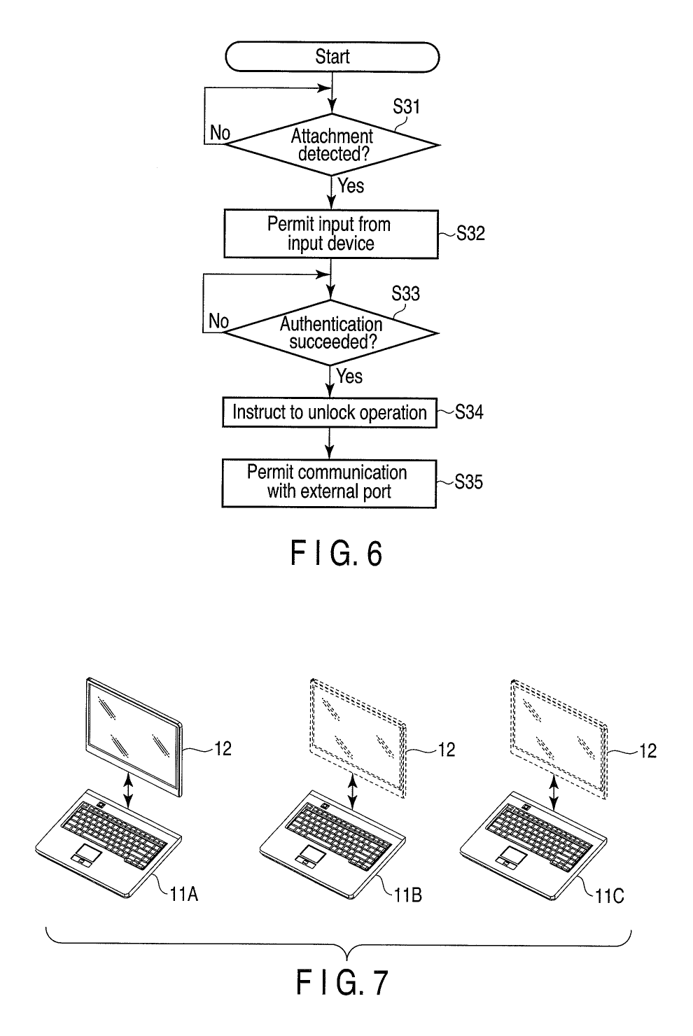

The sequence of processing to be executed by the utility program 202 and the like will be described below with reference to the flowchart shown in FIG. 5.

If the detection circuit 116 detects detachment of the display unit 12 from the main body 11 (Yes in block S11), the determination module 301 determines with reference to the setting file 304 whether or not the setting file 304 includes the setting to switch the computer 10 to the sleep state (block S12). If the setting file 304 includes the setting to switch the computer 10 to the sleep state (Yes in block S12), the determination module 301 determines whether or not the computer 10 is permitted to be switched to the sleep state (block S13).

If it is determined that the computer 10 is permitted to switch to the sleep state (Yes in block S13), the determination module 301 instructs the sleep instruction module 303 to issue an instruction required to switch the computer 10 to the sleep state (block S14). The sleep instruction module 303 instructs the operating system 201 to set the computer 10 in the sleep state. In response to the instruction from the sleep instruction module 303, the operating system 201 sets the computer 10 in the sleep state (block S15).

If it is determined that the setting file 304 does not include any setting to switch the computer 10 to the sleep state (No in block S12), or if it is determined that the computer 10 is inhibited from being switched to the sleep state (No in block S13), the determination module 301 instructs the lock instruction module 302 to issue an instruction required to lock the operation of the computer 10 (block S21). In response to the instruction from the determination module 301, the lock instruction module 302 instructs the operating system 201 to inhibit communications between the controller 119A and an external device (e.g., the flash drive 210) connected to the port 119B. The operating system 201 inhibits communications between the controller 119A and the external device connected to the port 119B (block S22). Also, the lock instruction module 302 instructs the operating system 201 to invalidate inputs of signals from the input device 321 including the keyboard 13 and touchpad 15 to the computer 10 (block S23). The operating system 201 invalidates inputs from the input device 321 in response to the instruction from the lock instruction module 302.

With the aforementioned processes, when the display unit 12 is detached from the main body 11, data in the computer 10 can be prevented from being extracted by setting the computer 10 in the sleep state or locking the operation of the computer 10.

The sequence of processing when the display unit 12 is attached from a state in which the port is inhibited from being used will be described below.

If the detection circuit 116 detects attachment of the display unit 12 (Yes in block S31), the unlock instruction module 312 instructs the operating system 201 to release the invalidated inputs of signals from the input device 321 to the computer 10. The operating system 201 releases the invalidated inputs of signals from the input device 321 to the computer 10 (block S32).

The authentication processing module 311 displays a window that prompts the user to input a password on the LCD 17 so as to execute authentication processing. If the input password matches a password which is registered in advance (Yes in block S33), the authentication processing module 311 instructs the unlock instruction module 312 to issue an instruction required to unlock the operation of the computer 10 to the operating system 201 (block S34). In response to the instruction from the authentication processing module 311, the unlock instruction module 312 instructs the operating system 201 to permit communications between the controller 119A and the external device connected to the port 119B. The operating system 201 permits communications between the controller 119A and the external device connected to the external port 119B (block S35).

When the display unit 12 is attached in the sleep state, the authentication processing is executed by the function of the operating system 201. When the authentication processing has succeeded, the user can use the computer 10.

With the aforementioned processes, when the display unit 12 is attached, an authentic user can use the computer 10 again.

In the above description, the main body 11 and display unit 12 have a one-to-one correspondence. However, a plurality of main bodies 11 may be combined with a single display unit 12.

For example, assume that three computers A to C are prepared for the display unit 12, as shown in FIG. 7.

1. Initially, the user uses the display unit 12 in combination with a main body 11A of computer A. Computer A is executing heavy-load processing.

2. During this processing, the user combines the display unit 12 with a main body 11B of computer B to execute another processing by computer B.

3. Computer A continuously executes the processing. However, since no display unit 12 is attached to computer A in state 2, it becomes difficult for the user to operate the main body 11A of computer A. On the other hand, in this state, it is possible for a third party to operate the main body 11A so as to make an unauthorized access to computer A. For this reason, in order to suppress such access from a third party to computer A, the aforementioned functions are applied to inhibit communications via the external port 119B and to lock use of the input device 321, thereby locking the operation of the main body 11A.

4. The user completes the processing on computer B, and combines the display unit 12 with a main body 11C of computer C to execute processing using computer C which manages other data.

5. Since computer B is not required to be ON, when the user detaches the display unit 12 from the main body 11B, he or she designates computer B to automatically set in the sleep state.

6. When the user uses computer A again, he or she combines the display unit 12 with the main body 11A.

7. When the display unit 12 is attached to the main body 11A, computer A prompts the user to make an authentication action so as to confirm if the user is an authentic user.

8. When the authentication has succeeded, communications via the external port 119B are permitted and inputs from the input device 321 are unlocked, thus permitting accesses to the main body 11A.

In the above embodiment, communications between the USB controller and external device have been exemplified. However, the present invention can also be applied to communications between a controller, which is compliant with, e.g., IEEE1394, ExpressCard, Ethernet®, eSATA, or SD standard, and an external device.

As described above, the user can securely use a single display unit 12 in combination with a plurality of computers without impairing convenience.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus from which a display is detachable, the apparatus comprising:
an input device configured to input data to the processor;
a processor configured to execute arithmetic processing;
a controller configured to communicate with an external device;
a detection circuit configured to detect an attachment and a detachment of the display;
a determination module configured to determine whether the information processing apparatus is allowed to be switched to a sleep state when the detection circuit detects the detachment;
a switching module configured to switch the information processing apparatus to the sleep state when the determination module determines that the information processing apparatus is allowed to be switched to the sleep state; and
a lock module configured to inhibit a communication between the external device and the controller and to invalidate an input of data from the input device to the processor when the determination module determines that the information processing apparatus is not allowed to be switched to the sleep state.

2. The apparatus of claim 1, further comprising:
a release module configured to validate the input when the attachment is detected in a state in which the communication is inhibited and the input is invalidated;
an authentication processor configured to execute an authentication process in a state in which the release module has validated the input; and
a communication permission module configured to permit the communication if the authentication process is successful.

3. The apparatus of claim 1, further comprising:
an authentication processor configured to resume the information processing apparatus from the sleep state and to execute an authentication process when the attachment is detected while the information processing apparatus is in the sleep state; and
a permitting module configured to permit the use of the information processing apparatus if the authentication process is successful.

4. The apparatus of claim 1, wherein the determination module is configured to determine that the information processing apparatus is allowed to be switched to the sleep state when a usage rate of the processor is lower than a predetermined value.

5. The apparatus of claim 1, further comprising a video signal wireless transmission module configured to transmit a video signal to the display via a wireless communication, when the detachment is detected.

6. The apparatus of claim 5, wherein the video signal wireless transmission module is configured to transmit the video signal according to either the wireless High-Definition Multimedia Interface (HDMI) specification or the wireless Universal Serial Bus (USB) specification.

7. A control method of an information processing apparatus comprising a detachable display and a processor configured to execute arithmetic processing, the method comprising:
detecting a detachment of the display;
determining, in response to detection of the detachment, whether the information processing apparatus is allowed to be switched to a sleep state;
switching the information processing apparatus to the sleep state when it is determined that the information processing apparatus is allowed to be switched to the sleep state; and
inhibiting a communication between an external device connected to a port of the information processing apparatus and a controller of the information processing apparatus, and invalidating an input of data from an input device to the processor when it is determined that the information processing apparatus is not allowed to be switched to the sleep state.

8. The method of claim 7, further comprising:
validating the input, and executing an authentication process when an attachment of the display is detected in a state in which the communication is inhibited and the input is invalidated; and
permitting the communication if the authentication process is successful.

9. The method of claim 7, further comprising:
resuming the information processing apparatus from the sleep state and executing an authentication process, when an attachment of the display is detected while the information processing apparatus is in the sleep state; and
permitting the use of the information processing apparatus if the authentication process is successful.

10. The method of claim 7, wherein whether the information processing apparatus is permitted to be switched to the sleep state is determined based on a usage rate of the processor.
